(19) United States
(12) Patent Application Publication
(10) Pub. No.: US 2014/0307089 A1
(43) Pub. Date: Oct. 16, 2014

(54) VIDEO CONVERSION DEVICE

(71) Applicant: VIVOTEK INC., New Taipei (TW)

(72) Inventors: Shyh-Yih MA, New Taipei (TW); Jen-Chih WU, New Taipei (TW)

(73) Assignee: VIVOTEK INC., New Taipei (TW)

(21) Appl. No.: 14/175,626

(22) Filed: Feb. 7, 2014

(30) Foreign Application Priority Data
Apr. 10, 2013 (TW) 102112761

(51) Int. Cl. H04N 7/18; H04N 7/01

(52) U.S. Cl. CPC H04N 7/18; H04N 7/01
USPC 348/143

(57) ABSTRACT

A video conversion device includes a video signal input port, an audio signal input port, a signal processing module and a signal output module. The video signal input port and a video capture device is connected via a connecting assembly having a plug and a socket for receiving an external analog video signal from the video capture device. The audio signal input port receives an analog audio signal. The signal processing module connects to the video signal input port and the audio signal input port to receive the analog video signal and the analog audio signal. The signal processing module respectively converts the external analog video signal and the analog audio signal to a digital video signal and a digital audio signal. The signal output module connects to the signal processing module to output the digital video signal and the digital audio signal.

### CROSS-REFERENCE TO RELATED APPLICATIONS

This non-provisional application claims priority under 35 U.S.C. §119(a) on Patent Application No(s). 102112761 filed in Taiwan, R.O.C. on Apr. 10, 2013, the entire contents of which are hereby incorporated by reference.

### TECHNICAL FIELD

The disclosure relates to a video conversion device, more particularly to a video conversion device with a heat dissipation structure.

### BACKGROUND

For analog surveillance products, images may be distorted after analog video signals are transmitted a long way. Alternately, since the analog video signals are easily interfered by external noises during the transmission, the quality of images may become unstable.

Recently, with the development of internet and the publication of surveillance products, surveillance products in the security surveillance market are inclined to be cyberized and digitalized and integrate multiple functions. Therefore, as a surveillance product, a conventional closed-circuit television (CCTV) is replaced by an internet-protocol camera (IP-Camera).

Analog surveillance products are intended to be digitalized. For digital surveillance products, digital video signals have better quality and resolution of images and have better transmission security. Moreover, digital signals can integrate relative information and surveillance functions together. Therefore, digital surveillance products can save human resources for maintaining system's operation and save cost.

Furthermore, since the network environment where surveillance systems are implemented is being changed from a closed network to the Internet, users may monitor relative images and information anywhere around the world. Digital surveillance systems nowadays may integrate a video recoding structure with one or more additional functions such as the movement detection, the live audio recording, the active notification and etc. according to user requirements.

Since digital surveillance systems have many advantages, it would be better to directly replace all analog surveillance systems by digital surveillance systems if possible. However, this will cause all these analog surveillance systems to become wasted. To prevent these analog surveillance systems from becoming wasted, they should be upgraded.

In a conventional surveillance system as shown in FIG. 1, an analog video camera 110 receives an analog video signal and transmits the analog video signal to a video server 140 through an analog line 130. The video server 140 converts the analog video signal into a digital video signal and converts an analog microphone input signal 160 into a digital audio signal, and the digital signals (i.e. the digital audio signal and the digital video signal) can be sent to an Internet 170 wiredly (e.g. Ethernet) or wirelessly. Since to convert signals needs to add a video conversion apparatus in the video server 140, this will increase the cost of the surveillance system and increase the volume of the video server 140.

The analog video camera 110 also needs an external power source 120 for its operation, and the video server 140 needs another external power source 150 for its operation. In other words, the surveillance system needs two external power sources for its operation. However, the arrangement of power lines of the two external power sources is more complicated, and the cost on the power lines will be added. Moreover, if the analog line 130 is too long, signals transmitting in the analog line 130 will be attenuated.

### SUMMARY

According to one or more embodiments, the disclosure provides a video conversion device including a video signal input port, an audio signal input port, a signal processing module and a signal output module. The video signal input port connects to a video capture device and receives an external analog video signal from the video capture device. The audio signal input port receives an analog audio signal. The signal processing module connects to the video signal input port and the audio signal input port, receives the external analog video signal and the analog audio signal, and respectively converts the external analog video signal and the analog audio signal into a digital video signal and a digital audio signal. The signal output module connects to the signal processing module and outputs the digital video signal and the digital audio signal.

In one embodiment, the video conversion device further includes a heat dissipating component connecting to the signal processing module and the video signal input port to conduct the heat caused by the signal processing module to the video signal input port.

In one embodiment, the heat dissipating component is sufficiently L-shaped.

In one embodiment, the video signal input port is a coaxial cable connector.

In one embodiment, the video conversion device further includes a power line assembly for receiving external power.

In one embodiment, the power line assembly is a power divider for delivering the external power to the video conversion device and the video capture device.

In one embodiment, the digital video signal and the digital audio signal outputted by the signal output module are Ethernet signals or wireless network signals.

In one embodiment, the audio signal input port further receives a microphone input signal.

In one embodiment, the video conversion device further includes a digital signal input port for receiving a digital signal generated by a peripheral device.

### BRIEF DESCRIPTION OF THE DRAWINGS

The present disclosure will become more fully understood from the detailed description given herein below for illustration only and thus does not limit the present disclosure, wherein:

FIG. 1 is a schematic view of a conventional surveillance system;

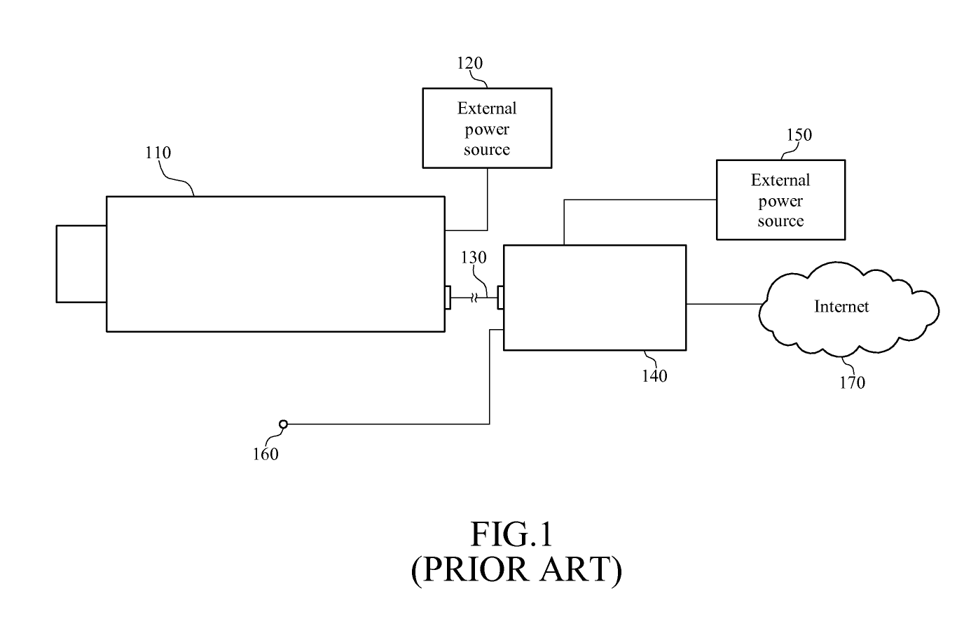

FIG. 2 is a schematic view of a surveillance system in the disclosure;

FIG. 3 is a block diagram of a surveillance system according to an embodiment;

FIG. 4 is a schematic view of a surveillance system according to an embodiment;

FIG. 5 is a schematic view of a surveillance system according to an embodiment;

FIG. 6 is a schematic view of a surveillance system according to an embodiment;

FIG. 7 is a schematic view of a surveillance system according to an embodiment; and

FIG. 8 is a schematic view of a surveillance system according to an embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

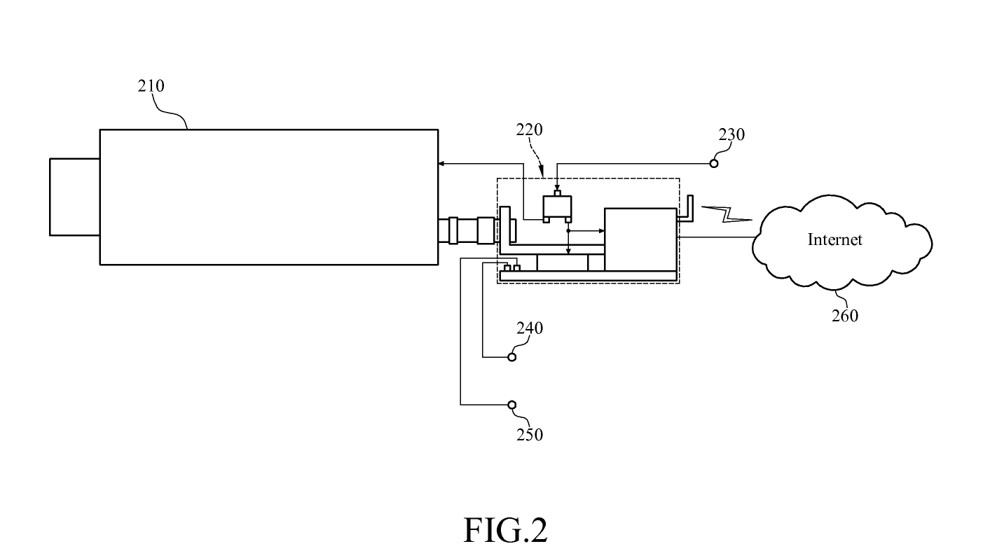

The disclosure provides a minimized surveillance system as shown in FIG. 2. In FIG. 2, a video conversion device 220 integrates the analog video capturing function, the analog audio capturing function and the digital signal capturing function together. The video conversion device 220 connects to a video capture device 210 via a connecting assembly with a plug and a socket, converts analog video signals outputted by the video capture device 210, analog audio signals 240 and external digital signals 250 into digital video signals and digital audio signals, and transmits the digital video signals and the digital audio signals to an Internet 260. Digitalized video and audio signals may have better signal quality and be suitable to be transmitted in longer paths.

Moreover, the video conversion device 220 includes heat dissipation components connecting to internal heat producing elements and connection ports so that the heat in the video conversion device 220 can be diffused out of the video conversion device 220. The video conversion device 220 further includes a power divider through which the external power 230 can be delivered to the video conversion device 220 and the video capture device 210 whereby the power lines can be shared.

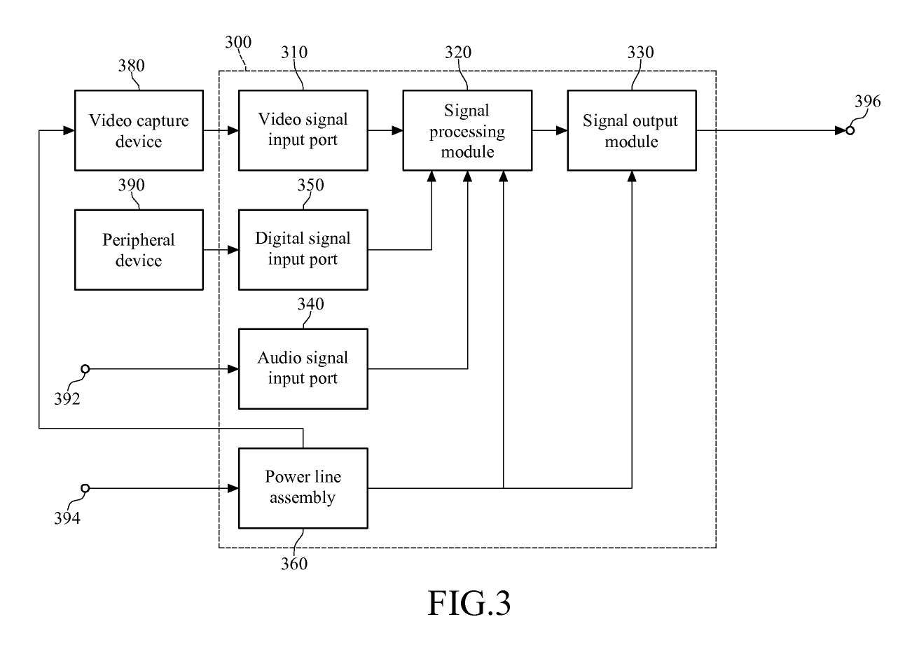

FIG. 3 is a block diagram of a surveillance system according to an embodiment. In the surveillance system, a video conversion device 300 includes a video signal input port 310, a signal processing module 320, a signal output module 330, an audio signal input port 340, a digital signal input port 350 and a power line assembly 360. The signal processing module 320 electrically connects to the video signal input port 310, the signal output module 330, the audio signal input port 340, the digital signal input port 350 and the power line assembly 360, and the power line assembly 360 also electrically connects to the signal output module 330.

The video signal input port 310 electrically connects to a video capture device 380 via a connecting assembly with a plug and a socket. That is, while the video signal input port 310 includes a plug, the video capture device 380 includes a socket, and vice versa. For example, the connecting assembly is a set of paired Bayonet Neill-Concelman (BNC) connectors, a set of paired AV ports (Composite Video Connector) or a set of paired radio corporation of America (RCA) ports. The video signal input port 310 receives external analog video signals from the video capture device 380, and transmits the external analog video signal to the signal processing module 320.

The audio signal input port 340 receives a microphone input signal 392 and transmits the microphone input signal 392 to the signal processing module 320. The digital signal input port 350 receives a digital signal from a peripheral device 390, and transmits the digital signal to the signal processing module 320.

The signal processing module 320 converts the external analog video signal to a digital video signal and transmits the digital video signal to the signal output module 330. The signal processing module 320 converts the microphone input signal 392 into a digital audio signal and transmits the digital audio signal to the signal output module 330. Moreover, the signal processing module 320 further transfers the digital signal outputted by the digital signal input port 350 to the signal output module 330.

The signal output module 330 respectively converts the digital video signal and the digital audio signal outputted by the signal processing module 320 to a first signal 396 which may be a digital network signal.

The power line assembly 360 electrically connects to the video capture device 380. The power line assembly 360 receives an external power 394 and delivers the external power 394 to the signal processing module 320, the signal output module 330 and the video capture device 380.

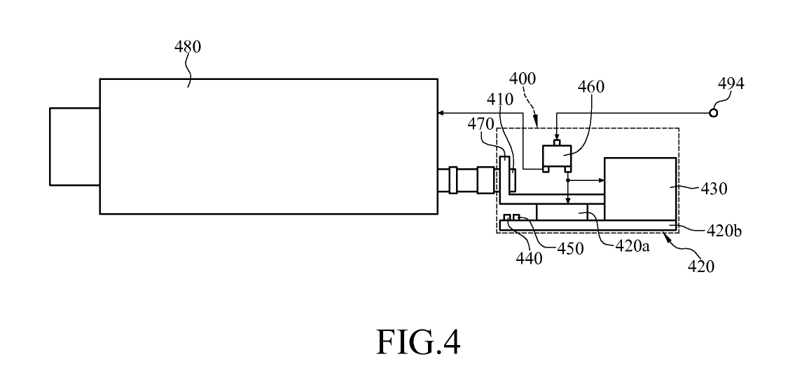

FIG. 4 is a schematic view of a surveillance system according to an embodiment. In the surveillance system, a video conversion device 400 includes a video signal input port 410, a signal processing module 420, a signal output module 430, an audio signal input port 440, a digital signal input port 450, a power line assembly 460 and a heat dissipating component 470. The heat dissipating component 470 connects to the signal processing module 420 and the video signal input port 410, and conducts the heat caused by the signal processing module 420 to the video signal input port 410.

To conduct the heat to the video signal input port 410 may be based on the material of signal input ports. For example, the video signal input port 410 is a BNC connector which connects to the BNC connector of the video capture device 480. Since the BNC connector is a metal component, the BNC connector can transmit electrical signals and conduct heat. The video signal input port 410 can also be an AV port or a RCA port.

The signal processing module 420 includes a signal processing component 420a and a carrier board 420b. The signal processing component 420a can convert analog video signals, analog audio signals and digital input signals into digital signals. The carrier board 420b carries the signal processing component 420a, electrically connects to other components and circuits, and is, for example, a printed circuit board (PCB) or a flexible print circuit (FPC).

The signal output module 430 receives the digital signals outputted by the signal processing module 420, and encodes and outputs the digital signals. The outputted and encoded digital signals are, for example, Ethernet signals or wireless network signals.

The audio signal input port 440 is an analog signal port, and may receive an analog audio signal transmitted from an analog microphone connected to the audio signal input port 440. The analog microphone may be, for example, an external analog microphone outside the video conversion device 400 or an analog microphone built in the video conversion device 400. The digital signal input port 450 is a digital signal port and receives digital input signals from external peripheral devices. For example, the peripheral device is a passive infrared sensor (PIR), a thermal sensor or a magnetic reed switch.

The power line assembly 460 is, for example, a power divider with three ports, one receives the external power 494 and the other two provide two power supplying paths. One power supplying path is for the signal output module 430 and the signal processing module 420, and the other power supplying path is for the video capture device 480. Through the power line assembly 460, the signal output module 430, the signal processing module 420 and the video capture device 480 can be powered. For example, the power line assembly 460 can be disposed outside or inside the video conversion device 400.

The video capture device 480 is, for example, a surveillance video camera with a metal case, outputs the analog video signals, and includes a metal BNC connector for outputting the analog video signals. The metal BNC connector connects to the metal case.

The heat dissipating component 470 is an L-shaped metal. One end of the L-shaped metal connects to the signal processing component 420a, and the other end of the L-shaped metal connects to the video signal input port 410. The L-shaped metal as the heat dissipating component 470 can conduct the heat produced by the signal processing component 420a to the video signal input port 410. Since the video signal input port 410 is a metal BNC connector directly connecting to the metal BNC connector of the video capture device 480, the heat caused by the signal processing component 420a will be conducted to the metal case of the video capture device 480. Moreover, since the heat dissipating component 470 is metallic, when the heat dissipating component 470 connects to the video signal input port 410, internal components of the video conversion device 400 may be held. Therefore, the case of the video conversion device 400 at the location of the video signal input port 410 may be prevented from the injury caused by the weight of the internal components.

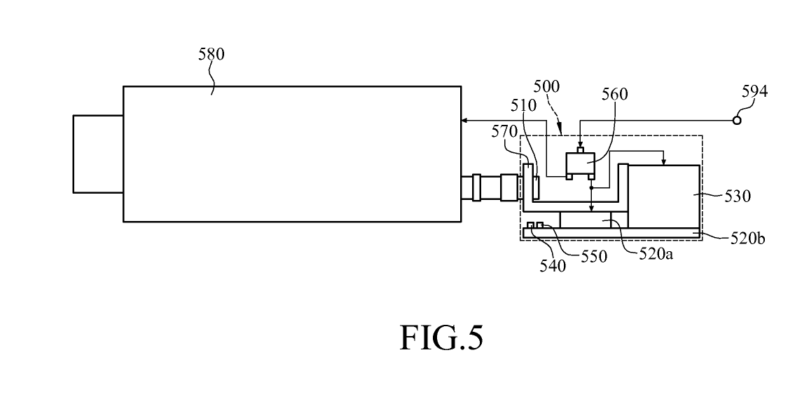

FIG. 5 is a schematic view of a video conversion device according to an embodiment. The differences between a video conversion device 500 in FIG. 5 and the video conversion device 400 in FIG. 4 are that the shape and connection of a heat dissipating component 570 are different those of the heat dissipating component 470. The operation and connection of components in the video conversion device 500 can be referred to the description of the video conversion device in FIG. 4 and thus are not repeated hereinafter. The shape and the connection of the heat dissipating component 570 are described below.

The heat dissipating component 570 is, for example, a U-shaped metal. One end of the U-shaped metal connects to the video signal input port 510, the middle section between the two ends of the U-shaped metal connects to the signal processing component 520a, and the other end of the U-shaped metal connects to the signal output module 530. Therefore, the heat dissipating component 570 can diffuse the heat caused by the signal output module 530 and the signal processing component 520a. Moreover, since the heat dissipating component 570 is metallic, when the heat dissipating component 570 connects to the video signal input port 510, internal components of the video conversion device 500 may be held. Therefore, the case of the video conversion device 500 at the location of the video signal input port 510 may be prevented from the injury caused by the weight of the internal components.

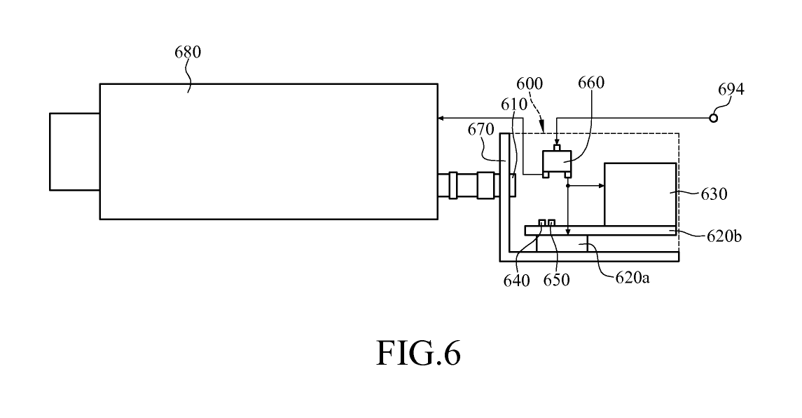

FIG. 6 is a schematic view of a video conversion device according to an embodiment. The differences between a video conversion device 600 in FIG. 6 and the video conversion device 400 in FIG. 4 are that the connection and location of a heat dissipating component 670 are different from those of the heat dissipating component 470. The connections and operations of other components in the video conversion device 600 can be referred to the video conversion device 400 in FIG. 4 and thus not repeated hereinafter. The connection and location of the heat dissipating component 670 are described below.

The heat dissipating component 670 is an L-shaped metal. One end of the L-shaped metal connects to a video signal input port 610, and the other end of the L-shaped metal connects to a signal processing component 620a. Therefore, the L-shaped metal can conduct the heat produced by the signal processing component 620a to the video signal input port 610, and then the video signal input port 610 conducts the heat to the metal case of the video capture device 680 to diffuse the heat. Since the heat dissipating component 670 is one part of the external case of the video conversion device 600, the other part of the external case can be nonmetal. In other words, the external case of the video conversion device 600 includes metal and nonmetal. Since the heat dissipating component 670 has a larger area where the heat dissipating component 670 contacts with the external air, it may enhance the efficiency of dissipating the heat from the signal processing component 620a and reduce the cost on the heat sinks inside the surveillance system. In one embodiment, the signal processing component 620a can be disposed under the carrier board 620b so that the heat dissipating component 670 can directly connect to the signal processing component 620a.

Moreover, since the heat dissipating component 670 is metallic, when the heat dissipating component 670 connects to the video signal input port 610, internal components of the video conversion device 600 may be held. Therefore, the case of the video conversion device 600 at the location of the video signal input port 610 may be prevented from the injury caused by the weight of the internal components.

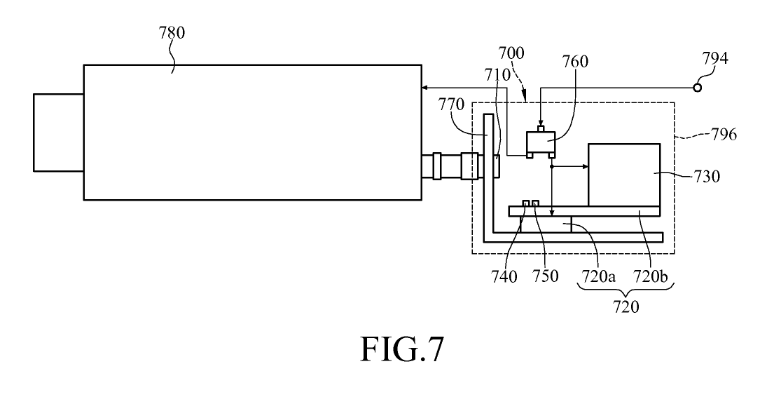

FIG. 7 is a schematic view of a video conversion device according to an embodiment. A video conversion device 700 in FIG. 7 includes a video signal input port 710, a signal processing module 720, a signal output module 730, an audio signal input port 740, a digital signal input port 750, a power line assembly 760 and a heat dissipating component 770. The heat dissipating component 770 connects to the signal processing module 720 and the video signal input port 710 and conducts the heat caused by the signal processing module 720 to the video signal input port 710.

To conduct the heat, caused by the signal processing component 720a operating, to the video signal input port 710 may be based on the material of the signal input port. For example, the video signal input port 710 is a BNC connector connecting to the BNC connector of the video capture device 780. Since the BNC connector is a metal component, the BNC connector can transmit electrical signals and conduct heat.

The signal processing module 720 includes a signal processing component 720a and a carrier board 720b. The carrier board 720b carries the signal processing component 720a and electrically connects to other components and circuits.

The heat dissipating component 770 is an L-shaped metal. One end of the L-shaped metal connects to the signal processing component 720a, and the other end of the L-shaped metal connects to the video signal input port 710. The difference between the heat dissipating component 770 and the heat dissipating component 670 in FIG. 6 is that the heat dissipating component 770 is separated from the case 796 of the video conversion device. Moreover, since the heat dissipating component 770 is metallic, when the heat dissipating component 770 connects to the video signal input port 710, internal components of the video conversion device 700 may be held. Therefore, the case of the video conversion device 700 at the location of the video signal input port 710 may be prevented from the injury caused by the weight of the internal components.

The connections and operations of other components in the video conversion device 700 can be referred to the video conversion device 600 in FIG. 6 and thus are not repeated hereinafter.

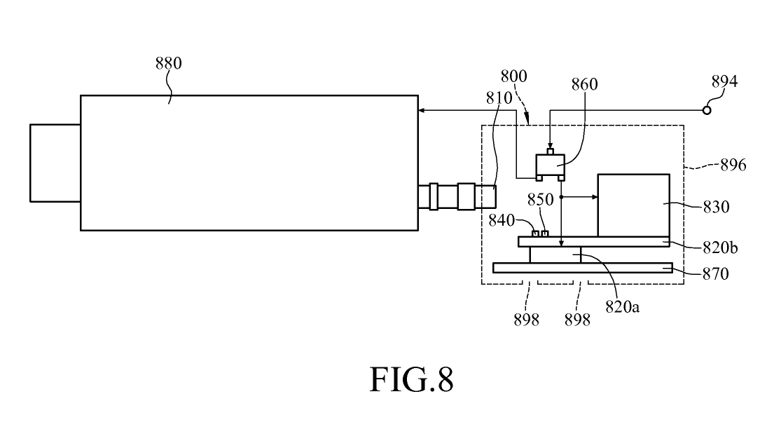

FIG. 8 is a schematic view of a video conversion device according to an embodiment. Compared with the embodiment in FIG. 7, a heat dissipating component 870 in FIG. 8 is not L-shaped, and connects to a signal processing component 820a. A heat dissipating component 870 is disposed in between an external case 896 and a carrier board 820b. The external case 896 has a plurality of cooling holes 898 whose location corresponds to the location of the signal processing component 820a, and the cooling holes 898 diffuse the heat caused by the signal processing component 820a to air outside the external case 896. The connections and operations of other components in the video conversion device 800 can be referred to the video conversion device 700 in FIG. 7 and thus are not repeated hereinafter.

In the above embodiments, the heat dissipating component may connect to the signal processing component through a thermal conductive material, so that the heat caused by the signal processing component can be conducted to the heat dissipating component.

As set forth above, the disclosure provides a video conversion device with a heat dissipating component, the video conversion device employs the heat dissipating component, through signal transmission ports, to dissipate the heat from heat producing elements connecting to the heat dissipating component. Since the heat dissipating component is metallic, when the heat dissipating component connects to the video signal input port, internal components of the video conversion device may be held. Therefore, the case of the video conversion device at the location of the video signal input port may be prevented from the injury caused by the weight of the internal components. Moreover, the video conversion device further includes a power divider which can power an external video capture device connecting to the video conversion device.

What is claimed is:

1. A video conversion device, comprising:
a video signal input port, connected to a video capture device via a connecting assembly having a plug and a socket and configured to receive an external analog video signal from the video capture device;
an audio signal input port, configured to receive an analog audio signal;
a signal processing module, connected to the video signal input port and the audio signal input port and configured to receive the external analog video signal and the analog audio signal, convert the external analog video signal into a digital video signal and convert the analog audio signal into a digital audio signal; and
a signal output module, connected to the signal processing module and configured to output the digital video signal and the digital audio signal.

2. The video conversion device according to claim 1, further comprising: a heat dissipating component, connected to the signal processing module and configured to dissipate the heat caused by the signal processing module.

3. The video conversion device according to claim 2, wherein the heat dissipating component further connects to the video signal input port and conducts the heat caused by the signal processing module to the video signal input port.

4. The video conversion device according to claim 3, wherein the heat dissipating component is sufficiently L-shaped.

5. The video conversion device according to claim 2, further comprising: an external case which the video conversion device is disposed inside, comprising a plurality of cooling holes.

6. The video conversion device according to claim 1, wherein the video signal input port is a coaxial cable connector.

7. The video conversion device according to claim 1, further comprising: a power line assembly configured to receive external power.

8. The video conversion device according to claim 7, wherein the power line assembly is a power divider configured to deliver the external power to the video conversion device and the video capture device.

9. The video conversion device according to claim 1, wherein the digital video signal and the digital audio signal outputted by the signal output module are Ethernet signals or wireless network signals.

10. The video conversion device according to claim 1, wherein the audio signal input port receives a microphone input signal.

11. The video conversion device according to claim 1, further comprising: a digital signal input port configured to receive a digital signal generated by a peripheral device.

12. The video conversion device according to claim 1, wherein the connecting assembly comprises a set of paired Bayonet Neill-Concelman (BNC) connectors, a set of paired AV ports or a set of paired radio corporation of America (RCA) ports.
